(19) United States
(12) Patent Application Publication
(10) Pub. No.: US 2021/0042865 A1
(43) Pub. Date: Feb. 11, 2021

(54) SYSTEM AND METHOD FOR PATENT ANNUITIES

(71) Applicants: ERICH LAWSON SPANGENBERG, PARIS (FR); DANIEL LAWRENCE BORK, EAST KINGSTON, NH (US); PASCAL ASSELOT, PARIS (FR)

(72) Inventors: ERICH LAWSON SPANGENBERG, PARIS (FR); DANIEL LAWRENCE BORK, EAST KINGSTON, NH (US); PASCAL ASSELOT, PARIS (FR)

(21) Appl. No.: 16/926,004

(22) Filed: Jul. 10, 2020

Related U.S. Application Data
(60) Provisional application No. 62/873,097, filed on Jul. 11, 2019.

(51) Int. Cl. G06Q 50/18; G06Q 40/06; G06Q 40/02; G06Q 20/10

(52) U.S. Cl. CPC G06Q 50/184; G06Q 20/102; G06Q 40/02; G06Q 40/06

(57) ABSTRACT

The invention is a platform for various patent related activities, including the budgeting and payment of annuity payments associated with various patent offices. The platform provides a network for uploading patent information and providing, among other things, budgets, multi-currency payment of options, and reminders for annuity payments. An AI component provides metrics on the necessity for payment certain patent annuities.

### PRIORITY CLAIMS

This application claims the benefit of U.S. Provisional Patent Application Ser. No. 62/873,097 filed on Jul. 11, 2019, which is incorporated herein by reference.

### BACKGROUND OF THE INVENTION

Patent annuity is the fee that is paid to a patent office to maintain a granted patent or patent application in force. It is also known as renewal fee or maintenance fee. Typically, in countries where renewal fee or continuance fee is to be paid annually, it is sometimes called patent annuity. Patent laws differ based on regulations concerning not only the amount payable but also the promptness of the payments.

Unfortunately, the differences in rules and regulations and the periods associated with annuities often leads to missed payments or abandonments based on missed payments. Three million patent applications were filed worldwide in 2016, according to statistics released by the World Intellectual Property Organization's “Facts and FIGS. 2017” report, and many more millions of patents are owned by entities across the globe. WIPR reports on the world of patent renewals.

Different countries have different patent rules, payable fees, and renewal processes. Those owning multiple patent families across different jurisdictions are therefore likely to find themselves in need of a system to help keep track of which patents need renewing, where, and when.

Another issue that results in patent abandonment is the complexity associated with the calculation of patent annuities. Often times it is difficult to determine the exact amount due across various countries and spaces. Given the significantly varying rules and currencies associated with patent annuities, patent owners may be found it difficult to determine the exact amount of payment. They may even be rejected for being “short” some value.

Currently, the only solutions associated with paying patent annuities, revolves around hiring various organizations that offer annuity payment services. Unfortunately, these organizations are not vetted and are typically require purchases of various software services associated with the annuity payments.

The present invention seeks to provide a solution involving a platform for patent registrations and transactions, that incorporates a patent verification process, a budget and quote process, a payment dashboard. The invention seeks to provide a blockchain or network connected interface wherein a user can input data regarding a patent, and automated reminders, payment options, and quick budget requirements are provided up front.

### SUMMARY OF INVENTION

A platform that could evaluate and determine the various deadlines and budget requirements for patent annuities is desired. the platform should provide a patent owner with a patent rating that allows a patent owner to determine the strength of the patent and the benefits and drawbacks from paying an annuity. It provides a clear and easy to read format so a patent owner can know the budget to maintain the patent throughout its life.

The current solution envisions a platform that determines the creditworthiness of an applicant during the sign-up process. It provides a report at a pre-determined variable period. The patent annuity can be handled either by a fund, or with an up-front payment from the patent owner. Once the patent owner has successfully loaded up their portfolio, the platform provides a report that highlights upcoming annuities, live/dead cases, associated fees.

The patent owner can categorize portfolio by combination of territories, families, due dates, annuity and/or a combination of patent Q scores and V scores. User can also include their own meta data and filter/categorize using this data. The meta fields are configurable.

To achieve this goal, a strong annuities offer is essential. The current model involves several companies exist who do little more than collect money a few days before the due date and pay the annuities.

The present invention provides benefits that allow for lower administrative price, lower operational cost due to the use of IBM's World Wire payment service, funding options, subscription payment service, AI to help choose which patents should be renewed, reviewed for sale, reviewed to license, and abandoned.

### BRIEF DESCRIPTION OF DRAWINGS

The various embodiments are illustrated by way of example, and not by way of limitation, in the figures of the accompanying drawings in which:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is an illustration of one aspect of the present invention.

FIG. 4 is a flow diagram describing the platform's methodology for annuity payments.

FIG. 5 depicts a flow diagram showing one embodiment of the annuity program payment features.

### DETAILED DESCRIPTION OF THE PREFERRED EMBODIMENT

A platform that could evaluate and determine the various deadlines and budget requirements for patent annuities is desired. the platform should provide a patent owner with a patent rating that allows a patent owner to determine the strength of the patent and the benefits and drawbacks from paying an annuity. It provides a clear and easy to read format so a patent owner can know the budget to maintain the patent throughout its life.

The current solution envisions a platform that determines the creditworthiness of an applicant during the sign-up process. It provides a report at a pre-determined variable period. The patent annuity can be handled either by a fund, or with an up-front payment from the patent owner. Once the patent owner has successfully loaded up their portfolio. the platform provides a report that highlights upcoming annuities, live/dead cases, associated fees.

The patent owner can categorize portfolio by combination of territories, families, due dates, annuity and/or a combination of patent Q scores and V scores. User can also include their own meta data and filter/categorize using this data. The meta fields are configurable.

To achieve this goal, a strong annuities offer is essential. The current model involves several companies exist who do little more than collect money a few days before the due date and pay the annuities.

The present invention provides benefits that allow for lower administrative price, lower operational cost due to the use of IBM's World Wire payment service, funding options, subscription payment service, AI to help choose which patents should be renewed, reviewed for sale, reviewed to license, and abandoned.

The current invention envisions a platform that determines the creditworthiness of an applicant during the sign-up process. It provides a report at a pre-determined variable period. The patent annuity can be handled either by a fund, or with an up-front payment from the patent owner.

In one embodiment, the patent owner has successfully loaded up their portfolio. the platform provides a report that highlights upcoming annuities, live/dead cases, associated fees.

In another embodiment, the patent owner can categorize portfolio by combination of territories, families, due dates, annuity and/or a combination of patent Q scores and V scores. User can also include their own meta data and filter/categorize using this data. The meta fields are configurable.

In another embodiment, the patent owner can filter by different defined categories (as per above). patent owner can the run a budget based on that filtered list of cases. In this budget, the patent owner can select/de-select cases to include (keep/abandon) to model costs. This can be configured by month, quarter, or year.

One embodiment will also include an itemized account of any financials including cost of credit etc. The patent owner can decide whether they want to pay in a single currency or in each individual currency.

In one embodiment, the patent owner can decide whether to pay all fees upfront (no funding) or to use the platform's funding facility.

In one embodiment, there are 4 options that the patent owner can work through for payment, in each scenario it is assumed that the platform secures the corresponding currencies and funds upfront.

In one embodiment, the patent owner selects one currency to be billed in and borrow the total invoice amount for the year. In this scenario, all local currency fees are converted into the selected currency at the platform's rate (ideally world wire so mid-market), with the cost of lending for the year included. This is then amortized into 12 equal subscription payments, made on a monthly basis.

In another embodiment, the patent owner pays in each individual currency and borrows the total invoice amount of each currency for the year, the platform's fee will remain in one currency (USD). In this scenario, there are no currency conversions, instead the patent owner receives an invoice total for each currency with the cost of lending for the year included. This is then amortized into 12 equal subscription payments, made on a monthly basis, for each currency.

In one embodiment, the patent owner selects one currency to be billed in and pay upfront. In this scenario, all local currency fees are converted into the selected currency at the platform's rate (ideally world wire so mid-market). The patent owner then makes a single upfront payment for total invoice amount.

In one embodiment, the patent owner pays in each individual currency and pays upfront, the platform's fee will remain in one currency (USD). In this scenario, there are no currency conversions and no cost of lending. The patent owner receives an invoice for each currency which they pay into the corresponding account.

In another embodiment, the patent owner should be able to export reports of budget, forecast and abandoned compared to retained cases. This will be .xls or .csv and will contain a summary view by defined timescale, as well as detailed case views and/or configurable category views. This is fixed for a certain number of days.

In one embodiment, once patent owner is satisfied, they can then fix the Patent Budget in the platform and request for the platform to secure funds for that year's annuity payments.

In another embodiment, once the Patent Budget is fixed, the patent owner executed payment based on their selected payment scenario.

In one embodiment, the patent owner has some new cases that need to be paid or some previously abandoned cases that they now want to renew.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

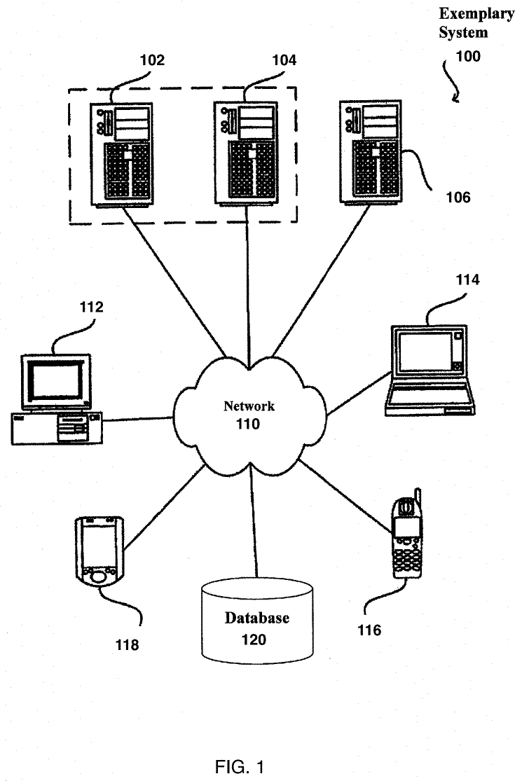

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java.®., C, C# or C++, and/or any scripting language, such as Perl, Python, or TCL, as well as combinations of any programming/scripting languages. The server(s) may also include database servers, including without limitation those commercially available from Oracle.®., Microsoft.®., Sybase.®., IBM.®. and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10 g, that is adapted to store, update, and retrieve data in response to SQL-formatted commands.

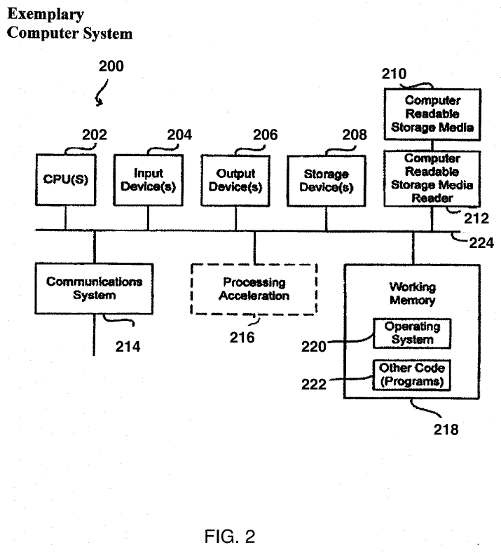

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like. The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third-party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.®. processor or the like. Similarly, a computer system (and additional instances of an enterprise database, where more than one is present) and all of their components might be operator configurable using application(s) including computer code run using a central processing unit such as an Intel Pentium.®. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java.™., JavaScript, ActiveX, any other scripting language such as VBScript, and many other programming languages as are well known. (Java.™. is a trademark of Sun Microsystems, Inc.).

In one embodiment, the present invention contains a method of transactions wherein all fees, payments, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

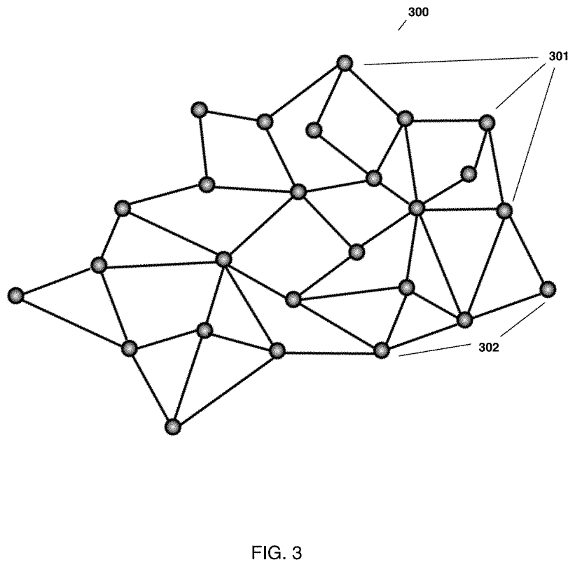

FIG. 3 depicts one aspect of the present invention. Specifically, the illustration shows the interconnection of each node 301 in a distributed decentralized network 300. In accordance with the preferred embodiment of the present invention, each node 301 in the distributed network 300 is directly connected to at least two other nodes 302. This allows each node 301 to transact with at least one other node 301 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

The above illustrations provide many different embodiments for implementing different features of the invention. Specific embodiments of components and processes are described to help clarify the invention. These are, of course, merely embodiments and are not intended to limit the invention from that described in the claims. In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources. A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices. The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

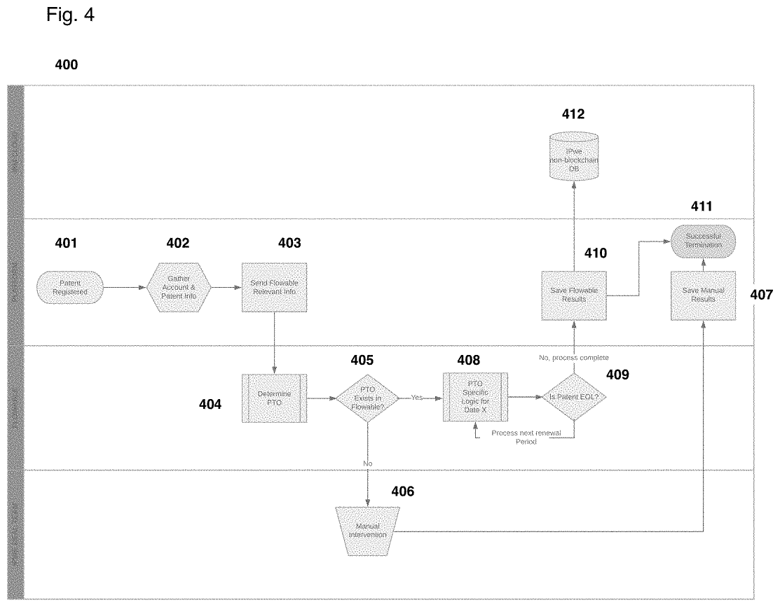

In one embodiment, shown in FIG. 4, and depicted by the FIG. 400, the patent is registered on the platform 401. The platform then further gathers account and patent information 402, sends relevant information to the patent owner 403, determines the correct PTO to seek fee calculations 404, determines if the PTO exists currently on the platform 405. Where the PTO does not exist, manual intervention 406 is used. These results for manual intervention are saved 407. Where it does exist, PTO specific logic is applied 108, the platform determines if the patent is eligible for renewal 409, and saves the results 410. The contract is terminated successfully 411. The results are passed to a non-blockchain database 412.

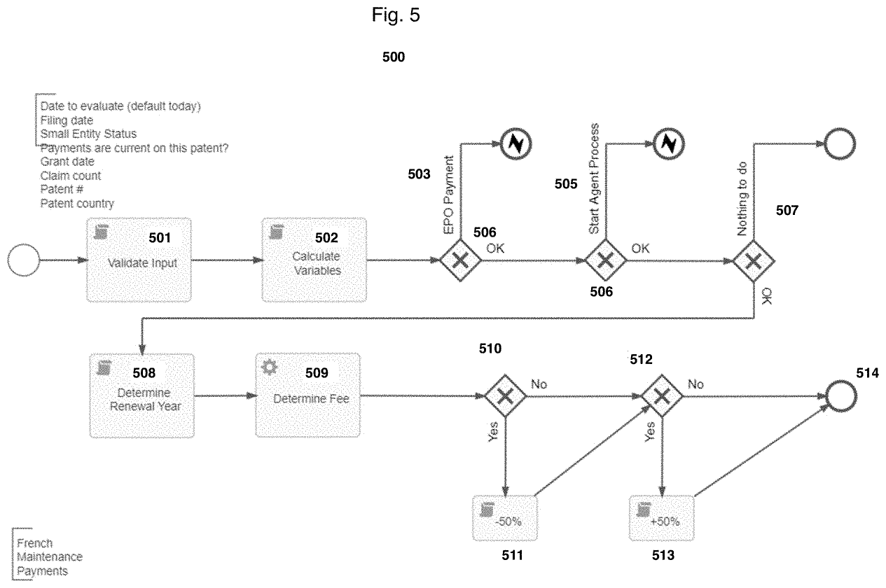

In one embodiment, show in FIG. 5, depicted by the number 500, the input is validated 501. Variables are calculated 502. If it checks out, 503, EPO payment is made 504. Otherwise, a determination is made to start the agent process 505. If so, the process is started 206. Otherwise, the flow passes to a null set 507. The renewal year is determined 508 the fee for renewal is determined 508, and if the owner wishes to make an upfront payment 509, the overall fees are reduced by 50% 510. The payment is then made 511 on the appropriate date 512. Otherwise the payment fee is not paid up front 513, the payment is increased by 50% 514, and the payment is made on the appropriate date 511.

In one embodiment, the patent owner can model the cost in the same platform and execute payment, If up to 30 days before, the patent owner can pay upfront with no cost of funding. In less than 30 days, the platform will secure funding with standard TAT and charge for the cost of securing funds (premium service fee). Within less than 7 days, the platform will introduce 3rd party agent to effect payment on client's behalf (managed via the platform interface).

The present system envisions a process of Loading Renewable Patents to a blockchain platform. The system will provide: Pay Date Planning Reports, Categorizing Patent Portfolios, Annuity Payment Networks, Cost Scenario Modeling and Decision Support, Cost Optimization, Funding Options and Subscription Payment Services, Ongoing Payment Status and Payment Monitoring, Upsell Opportunities, Liability & Indemnity Insurance, Lapsed Patent Restoration & Rejected Payment Services.

In one embodiment, the platform will provide automated patent verification workflows, agent payment management workflows, cost optimization support such as license of rights or paying in advance to receive a reduced fee, payment automation and tracking including rejected payments, lapsed patent restoration procedures tracked in an audited workflow, automated agent monitoring using key performance indicators (KPI) tracking, direct payments to USA, Korea, China, Japan, Germany, and France.

In another embodiment, the platform provides the ability to select the desired payment agents rated by other customers. the platform further provides data visualization widgets including AI Based portfolio grouping, cost scenario modeling, decision support, and full data visualization support to assist in the patent renewal & abandonment selection, multi-currency support, electronic agent verification and vetting process, funding solution for annual subscription model, title updates & licensing workflows to access LOR discounts, ad-hoc case acquisitions, direct payments to all EU countries plus Taiwan and Israel.

In another embodiment, the platform provides Insurance products, a law engine exposed to agents and law offices to maintain direct payments to 26 countries, annuity fee calculations, the compilation of the patent data for 91 regions, payments to 10 PTOs at a time.

In another embodiment, the platform will seek to eventually support all 230 patent offices, keep all of the rules and fee tables current through the use of AI and other technology.

In one embodiment, the platform provides 26 direct payment possibilities via APIs, other regions handled through agents.

In one embodiment, the agents are qualified. Qualified agents are compensated and vetted through the platform. Agents who work with the platform will have their fees passed through directly to the platform customer, Agents in the platform's annuities network will have priority access to other activities on the platform.

In one embodiment, the agents are monitored based on defined metrics. the platform automates the recording and display of these metrics to interested team members. the platform further provides an established a prioritized list of countries and a tool selected with an implementation for specifically available countries.

For each country, the platform accounts for fees, late fees, payment windows, missed payment criterion, payment date ranges, and late fee charges. the platform uses a payment workflow logic that will be very similar across countries when using an agent.

In one embodiment, a patent is uploaded on the Global Patent Registry. The platform verification team verifies the patents. Any discrepancy needs clarification from the patent owner. The System processes a budget and a quote.

In one embodiment, possible statuses include: decision required; decision made/invoice pending; decision made/invoice sent/payment pending; decision made/invoice sent/payment due; and decision made/payment received.

In one embodiment, customers can select subset of patent portfolio (“Managed Portfolio”). The platform reprocesses a quote and a customer agreement. The customer agrees to the quote, and provides bank account details. The contract is edited and executed online.

In one embodiment, the customer may terminate at any time. The platform presents and sends a status of Managed Portfolio, pending fees, projected schedule and completing its obligation.

In one embodiment, after the contract is executed, the platform sends at the beginning of the contract and every quarter an invite to take decisions on portfolio. AI suggests to renew or not. The owner has one month to take the decision on the platform dashboard.

In one embodiment, the default is renewing all new verified patents included. After a set period of time, the platform sends an invoice electronically. Payments are received from customers. If payment fails to be completed, related patents are withdrawn from the scope of the annuity payment agreement.

In one embodiment, the platform makes Payments to Patent Offices. In this case, the platform updates patent status to “payment acknowledgment pending” or “payment acknowledgment not available.” Subsequently, system received or checks for payment acknowledgment. Updates patent status to “payment acknowledged” is sent to the customer. the platform stores receipt information from Patent Office (where available).

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol. As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium. Any reference to “having”, “including” or “comprising” should be applied mutatis mutandis to “consisting” and/or “consisting essentially of.”

What is claimed is:

1. A patent annuity payment system, said system comprising:
a patent registration platform for gathering account and patent information to any of a plurality of patent owners, and
a patent annuity payment platform for determining accurate patent office fee calculations and identifying national patent offices interconnected with said patent annuity platform;
wherein said patent registration platform obtains funds from said patent owners and pays said accurate patent office fees to said national patent office when said patent annuities are owed so that patent annuities remain paid in a timely fashion.

2. A system according to claim 1 wherein said platform enables said patent owners to select a payment agent to tender payment to said patent annuity platform.

3. A system according to claim 2 wherein data visualization widgets include artificially intelligent portfolio grouping with cost scenario modeling to enable said patent owners to make advantageous decisions as to which patents to pay due annuities.

4. A system according to claim 3 wherein multi-currency support is enabled in response to artificially intelligent methods.

5. A method of using a patent annuity payment system, said method comprising:
loading data into a patent registration platform indicative of account and patent information pertaining to any of a plurality of patent owners, and
determining accurate patent office fee calculations through the use of a patent annuity payment platform for identifying national patent offices interconnected rate with said patent annuity platform;
wherein said patent registration platform obtains funds from said patent owners and pays said accurate patent office fees to said national patent office when said patent annuities are owed so that patent annuities remain paid in a timely fashion.

6. A method according to claim 5 wherein said platform enables said patent owners to select a payment agent to tender payment to said patent annuity platform.

7. A method according to claim 6 wherein data visualization widgets include artificially intelligent portfolio grouping with cost scenario modeling to enable said patent owners to make advantageous decisions as to which patents to pay due annuities.

8. A method according to claim 7 wherein multi-currency support is enabled in response to artificially intelligent methods.

9. A patent annuity payment system, said system comprising:
a patent registration platform for gathering account and patent information to any of a plurality of patent owners, and
a patent annuity payment platform for determining accurate patent office fee calculations and identifying national patent offices interconnected with said patent annuity platform;
wherein said patent registration platform obtains funds from said patent owners and pays said accurate patent office fees to said national patent office when said patent annuities are owed so that patent annuities remain paid in a timely fashion, and
wherein said platform enables said patent owners to select a payment agent to tender payment to said patent annuity platform, and
wherein data visualization widgets include artificially intelligent portfolio grouping with cost scenario modeling to enable said patent owners to make advantageous decisions as to which patents to pay due annuities, including multi-currency support enabled in response to artificially intelligent methods and including support for making pre-payment in advance at discounted rates in order to reduce fees charged to said patent owners.
